(19) United States
(12) Patent Application Publication
(10) Pub. No.: US 2023/0073600 A1
(43) Pub. Date: Mar. 9, 2023

(54) WELDING METHOD AND WELDING APPARATUS FOR WELDING CONDUCTOR ENDS

(71) Applicant: GROB-WERKE GmbH & Co. KG, MINDELHEIM (DE)

(72) Inventors: Konstantin HOFMANN, MINDELHEIM (DE); René SCHÜRER, MERING (DE)

(21) Appl. No.: 17/796,946

(22) PCT Filed: Jan. 25, 2021
(86) PCT No.: PCT/EP2021/051614

§ 371 Date: Aug. 2, 2022

(30) Foreign Application Priority Data
Feb. 12, 2020 (DE) 10 2020 103 609.4
May 15, 2020 (EP) 20175064.3

(51) Int. Cl. H02K 15/00; B23K 31/12; B23K 26/03; B23K 26/21; B23K 26/06; B23K 26/073; G01B 11/14

(52) U.S. Cl. CPC H02K 15/0081; B23K 31/125; B23K 26/032; B23K 26/21; B23K 26/0626; B23K 26/073; G01B 11/14; B23K 2101/38

(57) ABSTRACT

To improve quality and reduce reject in the large-scale production of components of an electrical machine provided with coil windings, a welding method is provided for welding conductor ends organized into groups of conductor ends of a component for an electrical machine. The method includes detecting a relative position of a first conductor end and a second conductor end of a group of conductor ends, and controlling a welding energy input to the conductor ends to be welded depending on the detected relative position. A welding apparatus for performing the welding method is also provided.

### CROSS-REFERENCES TO RELATED APPLICATIONS

This application claims the benefit of the International Application No. PCT/EP2021/051614, filed on Jan. 25, 2021, and of the German patent application No. 102020103609.4 filed on Feb. 12, 2020, and of the European patent application No. 20175064.3 filed on May 15, 2020, the entire disclosures of which are incorporated herein by way of reference.

### FIELD OF THE INVENTION

The invention relates to a welding method for welding conductor ends organized into groups of conductor ends of a component for an electrical machine. Further, the invention relates to a welding apparatus for welding conductor ends organized into groups of conductor ends of a component for an electrical machine, the welding apparatus comprising welding means for applying welding energy to a group of conductor ends. In particular, the invention relates to a method and an apparatus for welding conductor ends of groups of conductor ends, in particular pairs of conductor ends (hereinafter also referred to as pin pairs), of a component for an electric machine, in particular of a stator of an electric motor designed as a traction motor for an electric vehicle.

### BACKGROUND OF THE INVENTION

Electrical machines are understood, in particular, to mean machines for converting electrical energy into kinetic energy and machines for converting kinetic energy into electrical energy. In particular, these include electric motors and generators.

In the manufacture of components of such electrical machines, such as stators or rotors, it is often necessary to process ends of conductors formed from wires together, such as cutting or shaping them together, and to connect them together.

For example, there are electric motors in which coil windings, especially of the stator, are formed from different pieces of wire whose ends are then joined together. Devices and methods for joining wire ends of hairpins to form stator windings of electric machines have already been proposed, in which the wire ends are welded together. In this connection, devices and methods are provided for positioning and clamping the wire ends prior to welding, and devices and methods are provided for welding the wire ends thus clamped.

A preferred field of application of the present invention is in the field of manufacturing electric motors or other electric machines, such as generators, designed for high power, reliable operation and high efficiency. In particular, electric motors are to be manufactured which can be used as traction motors of electric vehicles or hybrid vehicles and have, for example, a rated power between 20 kW and 400 kW.

For this preferred field of application, the following literature

[1] EN 10 2018 103 926 A1

[2] EN 10 2018 103 929 A1

[3] EN 10 2018 103 930 A1,

which is explicitly referred to for further details, describes devices and methods for forming wire ends of hairpins and a manufacturing method for a component of an electric machine using the same. In particular, the devices and methods described in this literature are for forming hairpin wire ends that are joined together to form coil windings. The joining is carried out, for example, by means of welding, for which it is advantageous to use devices and methods for positioning and tensioning the hairpin wire ends shown and described in

[4] EN 10 2018 103 100 A1,

which is explicitly referred to for further details.

In this way, coil windings can be formed on a component of an electrical machine by welding pairs of conductor ends. Each such coil winding is operative only if all its welded joints are technically in order. For example, a stator will only function if all the welded joints of all its coil windings are technically in order. Since stators for the above-mentioned applications usually contain more than 200 pairs of conductor ends, this results in a high demand on weld quality, since even a single joint that is not in order is sufficient for the entire stator to be a reject.

### SUMMARY OF THE INVENTION

An object of the invention therefore is to make the production of electrical connections by welding on components of an electrical machine that is to be manufactured in large series more process-reliable.

To achieve this object, the invention provides a method and a device as well as a computer program product.

According to one aspect thereof, the invention provides a welding method for welding conductor ends organized into groups of conductor ends of a component for an electrical machine, comprising:

a) detecting a relative position of a first conductor end and a second conductor end of a group of conductor ends; and

b) controlling a welding energy input to the conductor ends to be welded depending on the detected relative position.

Preferably, the welding method comprises the steps of:

c) detecting at least one size parameter of a molten pool generated during welding; and

d) controlling the welding energy input depending on the detected size parameter of the molten pool.

Preferably, the welding method comprises the steps of:

e) detecting at least one size parameter of a weld bead solidified after welding; and

f) controlling the welding energy input during a subsequent welding of another group of conductors ends depending on the detected size parameter of the solidified weld bead.

The steps as a) through f), a1), a2), etc. are given here only for ease of reference and are not intended to imply any requirement as to sequence or presence of steps, i.e., an embodiment may include, for example, steps e) and f) without steps c) or d).

It is preferred that step e) is performed on a first group of conductors ends, while step b) is already being performed on a second group of conductor ends.

It is preferred that step e) is carried out to characterize the welding result. The term “characterizing” includes, in particular, an analysis of the length extension and/or width extension of the weld bead formed during a previous welding operation. For example, based on the extent and/or position of the weld bead, the weld result may be classified into one of a plurality of categories, each category being associated with a predetermined control action for controlling the welding energy input of one of the subsequent welding operations.

It is preferred that step e) comprises comparing the at least one size parameter to a predetermined parameter value or parameter value range.

It is preferred that step a) comprises the step of:

a1) position measurement of the relative position using optical measuring methods.

It is preferred that step a) comprises the step of:

a2) position measurement of the relative position by means of time-of-flight measurement of reflected radiation.

It is preferred that step a) comprises the step of:

a3) performing an optical coherence tomography.

It is preferred that step a) comprises the step of:

a4) alternately directing a measuring radiation to different groups of conductor ends.

It is preferred that step a) comprises the step of:

a5) measuring distances or stretches in at least two dimensions at the group of conductor ends.

It is preferred that step a) comprises the step of:

a6) measuring a distance or a stretch in the direction of the extension of the conductor sections comprising the conductor ends.

It is preferred that step a) comprises the step of:

a7) measuring a distance between the ends of the conductor.

It is preferred that step a) comprises the step of:

a8) measuring a height offset between the ends of the conductor.

It is preferred that step a) comprises the step of:

a9) measuring a cross-sectional area of the end region of the group of conductor ends.

It is preferred that step a) comprises the step of:

a10) measuring a volume of the end region of the group of conductor ends.

It is preferred that step a) comprises the step of:

a11) measuring a thickness, a width and/or a height of the end region at the group of conductor ends.

It is preferred that step a) comprises the step of:

a12) detecting a change in at least one dimension of the end region of the group of conductor ends. For example, absolute values and/or changes can be recorded for all measurements mentioned in steps a1) to a11).

It is preferred that step c) comprises the step of:

c1) position measurement of the molten pool using optical measuring methods.

It is preferred that step c) comprises the step of:

c2) position measurement of the molten pool by means of time-of-flight measurement of reflected radiation.

It is preferred that step c) comprises the step of:

c3) performing an optical coherence tomography.

It is preferred that step c) comprises the step of:

c4) alternately directing a measuring radiation to different groups of conductor ends.

It is preferred that step c) comprises the step of:

c5) measuring distances or stretches of the molten pool in at least two dimensions at the group of conductor ends.

It is preferred that step c) comprises the step of:

c6) measuring a distance or stretch of the molten pool in the direction of the extension of the conductor sections having the conductor ends.

It is preferred that step c) comprises the step of:

c7) determine a distance between the conductor ends where the molten pool is formed.

It is preferred that step c) comprises the step of:

c8) measuring a height offset between the conductor ends where the molten pool is formed.

It is preferred that step c) comprises the step of:

c9) determining a cross-sectional area of the molten pool.

It is preferred that step c) comprises the step of:

c10) determining a volume of the molten pool.

It is preferred that step c) comprises the step of:

c11) measuring a thickness, a width and/or a height of the molten pool.

It is preferred that step c) comprises the step of:

c12) detecting a distance between the weld pool and one or more adjacent group(s) of conductor ends. In particular, an air and creepage distance between welded groups of conductor ends can be detected and monitored so that a minimum air and creepage distance is not undercut.

It is preferred that step c) comprises the step of:

c13) detecting a change in at least one dimension of the molten pool. For example, absolute values and/or changes can be recorded for all measurements mentioned in steps c1) to c12).

It is preferred that step e) comprises the step of:

e1) position measurement of the weld bead using optical measuring methods.

It is preferred that step e) comprises the step of:

e2) position measurement of the weld bead by means of time-of-flight measurement of reflected radiation.

It is preferred that step e) comprises the step of:

e3) performing an optical coherence tomography.

It is preferred that step e) comprises the step of:

e4) alternately directing a measuring radiation to different groups of conductor ends.

It is preferred that step e) comprises the step of:

e5) measuring of distances or stretches in at least two dimensions at the weld bead.

It is preferred that step e) comprises the step of:

e6) measuring a distance or stretch of the weld bead in the direction of the extension of the conductor sections comprising the conductor ends.

It is preferred that step e) comprises the step of:

e7) measuring a distance between the ends of the conductor where the weld bead has formed.

It is preferred that step e) comprises the step of:

e8) measuring a height offset between the ends of the conductor where the weld bead has formed.

It is preferred that step e) comprises the step of:

e9) determining a cross-sectional area of the weld bead.

It is preferred that step e) comprises the step of:

e10) determining a volume of the weld bead.

It is preferred that step e) comprises the step of:

e11) measuring a thickness, a width and/or a height of the weld bead.

It is preferred that step e) comprises the step of:

e12) detecting a distance of the weld bead to one or more adjacent group(s) of conductor ends. In particular, an air and creepage distance between welded groups of conductor ends can be detected and compared with a minimum air and creepage distance.

It is preferred that step e) comprises the step of:

e13) detecting a change in at least one dimension of the weld bead. For example, absolute values and/or changes can be recorded for all measurements mentioned in steps e1) to e12).

It is preferred that step b) comprises the step of:

b1) directing a welding beam onto the group of conductor ends.

It is preferred that step b) comprises the step of:

b2) starting the welding energy input to the group of conductor ends.

It is preferred that step b) comprises the step of:

b3) stopping the welding energy input to the group of conductor ends.

It is preferred that step b) comprises the step of:

b4) increasing or decreasing the welding energy input to the group of conductor ends.

It is preferred that step b) comprises the step of:

b5) changing a beam cross-section of a welding beam on the group of conductor ends.

It is preferred that step d) comprises the step of:

d1) directing a welding beam onto the group of conductor ends.

It is preferred that step d) comprises the step of:

d2) starting the welding energy input to the group of conductor ends.

It is preferred that step d) comprises the step of:

d3) stopping the welding energy input to the group of conductor ends.

It is preferred that step d) comprises the step of:

d4) increasing or decreasing the welding energy input to the group of conductor ends.

It is preferred that step d) comprises the step of:

d5) changing a beam cross-section of a welding beam on the group of conductor ends.

It is preferred that step f) comprises the step of:

f1) directing a welding beam onto the group of conductor ends which is currently to be welded.

It is preferred that step f) comprises the step of:

f2) starting the welding energy input to the group of conductor ends which is currently to be welded.

It is preferred that step f) comprises the step of:

f3) stopping the welding energy input to the group of conductor ends which is currently to be welded.

It is preferred that step f) comprises the step of:

f4) increasing or decreasing the welding energy input to the group of conductor ends which is currently to be welded.

It is preferred that step f) comprises the step of:

f5) changing a beam cross-section of a welding beam on the group of conductor ends which is currently to be welded.

Particularly preferably, the conductors are rectangular conductors with a rectangular cross-section. Preferably, the conductor ends have a rectangular cross-section.

Preferably, the welding method according to any of the preceding embodiments is performed by means of a welding apparatus according to any of the following embodiments. Preferably, the welding apparatus according to any one of the following embodiments is adapted to perform the welding method according to any one of the preceding embodiments.

According to a further aspect, the invention provides a welding apparatus for welding conductor ends organized into groups of conductor ends of a component for an electrical machine, comprising:

a welding means for applying welding energy to a group of conductor ends;

a measuring device for detecting a relative position of a first conductor end and a second conductor end of the group of conductor ends, and

a control device designed to control a welding energy input to the conductor ends to be welded depending on the detected relative position.

It is preferred that the measuring device is designed to detect at least one size parameter of a molten pool formed during welding, and that the control device is designed to control the welding energy input as a function of the detected size parameter of the molten pool.

It is preferred that the measuring device is designed to detect at least one size parameter of a weld bead that has solidified after welding, and that the control device is designed to control a welding energy input during subsequent welding of a further group of conductor ends as a function of the detected size parameter of the solidified weld bead.

It is preferred that the measuring device has at least one or more deflection mirrors by means of which measuring radiation can be selectively guided to different groups of conductor ends.

It is preferred that the measuring device is designed to measure the size parameter of the weld bead solidified after welding at a first group of conductor ends and, at the same time, to detect the relative position of the conductor ends and/or the size parameter of the molten pool already at a second group of conductor ends.

It is preferred that the measuring device is designed to evaluate the welding result. The evaluation includes in particular a characterization, as described above for an embodiment of the welding method.

It is preferred that the measuring device comprises a comparison device for comparing the at least one size parameter with a predetermined parameter value or parameter value range.

It is preferred that the measuring device is designed for position measurement by means of optical measuring methods.

It is preferred that the measuring device is designed for position measurement by means of time-of-flight measurement of reflected radiation.

It is preferred that the measuring device is designed to perform an optical coherence tomography.

It is preferred that the measuring device is designed for alternately directing a measuring radiation to different groups of conductor ends.

It is preferred that the measuring device is designed to measure distances or stretches in at least two dimensions at the group of conductor ends. It is particularly preferred that the measuring device is designed to measure distances or stretches in all three dimensions at the group of conductor ends.

It is preferred that the measuring device is designed to measure a distance or a stretch in the direction of the extension of the conductor sections comprising the conductor ends.

It is preferred that the measuring device is designed to measure a distance between the conductor ends.

It is preferred that the measuring device is designed to measure a height offset between the conductor ends.

It is preferred that the measuring device is designed to determine a cross-sectional area of the end region of the group of conductor ends.

It is preferred that the measuring device is designed to determine a volume of the end region of the group of conductor ends.

It is preferred that the measuring device is designed to measure a thickness, a width and/or a height of the end region at the group of conductor ends.

It is preferred that the measuring device is designed to detect a change in at least one dimension of the end region of the group of conductor ends.

Of course, the measuring device can be designed to perform several of the aforementioned measuring functions.

Preferably, the control device is designed to control the welding apparatus to direct a welding beam onto the group of conductor ends.

Preferably, the control device is designed to control the welding apparatus to start the input of welding energy to the group of conductor ends.

Preferably, the control device is adapted to control the welding apparatus to stop the input of welding energy to the group of conductor ends.

Preferably, the control device is designed to control the welding apparatus to increase or decrease the welding energy input to the group of conductor ends.

Preferably, the control device is configured to control the welding apparatus to change a beam cross-section of a welding beam on the group of conductor ends.

According to a further aspect, the invention provides a computer program product comprising machine-readable control instructions which, when loaded into a controller of a welding apparatus according to any one of the preceding embodiments, cause the welding apparatus to perform the welding method according to any one of the preceding embodiments. A controller in which such control instructions are loaded is an execution example of the control device of the preceding embodiments.

Effects, functions and advantages of preferred embodiments of the invention are explained in more detail below.

Preferred embodiments of the invention are used for welding in large-scale production of components of electrical machines, as described and shown from [1] to [4]. Explicit reference is made to these literature for further details. For example, copper wires are used as conductors in this process.

The contacting of copper wires (also called copper pins) to be electrically interconnected is carried out via material-to-material connections that can be produced with different welding methods. In addition to various beam welding methods such as laser beam or electron beam welding, arc-based processes such as TIG and plasma welding are currently established for this purpose. These welding methods are also used in various embodiments of the invention.

Preferably, the conductor ends to be contacted (hereinafter also referred to as pins) are welded in a parallel joint at their free ends, with the geometry of the weld connection forming a bead-shaped or hemispherical contour.

Preferably, the bond cross-section is set individually via the melt volume or the bead height, depending on the required mechanical and electrical properties. During the welding method, energy is applied over a wide area so that the end face is completely melted and a closed melt blanket results. In detail, the energy is introduced along a characteristic welding contour, the geometry and dimension of which are selected as a function of the wire cross section. The dimension of these contours extends over the entire cross section of the pin pair (example for a group of conductor ends), so that a constant and uniform melt blanket is produced. A characteristic melt volume is provided as a function of the required bond cross-section.

In previous welding methods, the welding contour must be repeated until the required bond cross-section is achieved. However, conventional processes and equipment do not provide for monitoring the melt volume with system-related measuring equipment and controlling the energy input depending on the situation. Rather, in conventional processes and devices, the process-technical control variables are selected in such a way that the required bond cross section is achieved even if unfavorable boundary conditions exist with regard to the pin positions. In comparison, ideal boundary conditions result in an oversized energy input. In principle, however, this has a negative effect on minimizing the stripped length (length over which an insulating layer has been removed from the conductor ends) and the welding time. In the worst case, with a combination of unfavorable boundary conditions with regard to the position offsets of the pins, tolerances cannot be compensated for arbitrarily, or the process parameters cannot be configured in such a way that arbitrarily high pin offsets can be compensated for. Such boundary conditions result in a welded joint whose bond cross section does not meet the requirements and thus represents a “niO” (“not correct”). Typically, a stator contains between 150 and 300 welded joints, whereby even a single niO welded joint leads to a rejection of the entire stator.

Therefore, embodiments of the invention provide for a situation-dependent adjustment of the energy input and thus a high process stability. From a systems engineering point of view, this can be achieved in preferred embodiments of the invention with a measuring tool that quantifies the pin positions with reliable evaluation variables before the welding method. In addition, an inline intervention option corresponding to the pin characteristics is preferred.

Preferably, an upstream position measurement of the pins is performed for each pin pair to be welded, since these can have an individual position in the x, y and z directions. Further preferably, an inline measurement of the process zone growth is also carried out for each welding method in order to be able to implement the energy input according to the situation.

Process monitoring systems currently used in existing solutions are limited to the detection of process emissions and also evaluate only the constancy of these evaluation variables. In addition to thermal variables, process luminescence and keyhole depth are detected and evaluated with regard to their constancy and scattering range. This method allows an evaluation of the process constancy over the process duration, whereby the changes in the signal course do not allow a direct conclusion to be drawn about the kind of defect. In the case of contamination of the stripped pins or position-related influences that induce spatter formation, no unambiguous conclusion can be drawn about their cause with the measured variables mentioned.

Furthermore, the methods proposed in previous approaches do not offer the possibility to quantify the process zone dimension during a welding method.

Preferred embodiments of the invention allow such quantification in order to control the energy input depending on the situation, so that a melt volume results that produces the required bond cross-section. This makes it possible to avoid over-dimensioned energy input as well as thermal damage to the insulation coating and, at the same time, bond cross-sections that are too small due to unfavorable boundary conditions.

So far, no inline detection of the resulting melt volume as a function of the pin position is possible in order to be able to control the energy input according to the situation.

The measurement methods and strategies proposed by previous approaches are not suitable for quantifying the melt formation and melt volume during a welding method in a process-reliable and reproducible manner. Accordingly, there is no possibility of controlling the energy input as a function of the melt volume Inline and thus depending on the situation.

However, depending on the above boundary conditions, the melt volume and thus the bond cross-section vary as the absorbed energy varies. This can be countered with the embodiments of the invention.

Preferred embodiments of the invention have, in particular, the following particularly advantageous features:

inline quantification of the process zone dimension for individual control of energy input when welding hairpins with undefined pin positions such as tangential, radial and height offset (TV, RV, HV).

a constant bond cross-section is possible independently of a possible combination of offsets and further boundary conditions.

In particular, this makes it possible to create a welding method for welding coil windings of a stator formed from individual conductor pieces, such as in particular U-shaped conductor pieces (hairpins), which has special advantages with regard to the functional capability of the stator. The functionality of a stator is only given if all welded joints are technically OK. Since stators usually contain more than 200 pin pairs, this results in high demands on the weld quality, since even one niO joint is sufficient, so that the entire stator is a reject. Such a high weld quality can be achieved with embodiments of the invention.

Embodiments of the invention provide for a measurement system that firstly quantifies the pin position in terms of offsets RV, TV and HV in one, two or three dimensions in order to determine the required area energy on a pin-by-pin basis, if necessary. Secondly, an Inline quantification of the melt volume is enabled to allow conclusions to be drawn about the bond cross-section and thus to implement an energy quantity adjusted to the pin pair.

In contrast to prior art, not only are process emissions such as the intensity of the plasma light or the temperature curve recorded and evaluated with regard to their constancy, but the evaluation proposed here also enables a correlation to the actual resulting melt volume.

A suitable measurement strategy is proposed to weld pin pairs reproducibly despite position deviations (e.g., radial offset RV, tangential offset TV, height offset HV) so that the required bond cross-sections result. This eliminates the need for upstream cutting of the hairpins.

Preferred designs of the developed measurement strategy allow an Inline quantification of the process zone dimension and thus an intervention limit as soon as the required melt volume or bond cross-section has been reached. This means that rejects due to insufficient bond cross-sections resulting from high gap dimensions or offsets can be avoided. Furthermore, upstream trimming of the pin heights can be dispensed with, so that a very large financial savings potential can be achieved per station.

Preferred system design: The measuring system is preferably based on optical coherence tomography, OCT for short: Here, for example, a measuring beam with a wavelength of approx. 840 nm is emitted. The height information of the component in the z-direction is determined by calculating the propagation time of the reflected signal.

The measurement strategy can be implemented as a double cross to characterize the positions of the uncut hairpins before welding in the x-y-z direction. According to the positions, a pin-related power distribution or area energy can be calculated so that a homogeneous weld bead results. Furthermore, the process zone dimension can be measured iteratively during the welding method in order to achieve defined limit values of the bond cross-section or not to exceed the permissible bead dimension. In detail, the change in length, width and height extension is quantified during the process. As the volume of the copper increases during melting, the height of the pin pair to be welded changes. With continued energy input, a complete melt blanket results until a lateral bead overhang occurs with sufficient melt volume. This is directly proportional to a specific melt volume and thus to a defined bond cross-section.

In detail, in a preferred embodiment, optical coherence tomography can be used to measure the change in process zone dimension during a welding method. Based on this, a correlation to the bond cross-section can be established. As soon as the desired melt volume or the required bond cross-section is available, the energy input can be stopped. In this way, a situation-dependent energy input can be implemented, which avoids scrap and increases the process capability.

Furthermore, in preferred designs, in addition to process control for setting individual target variables of the bead dimension and the bond cross-section, characterization of the welding results is also possible. Here, a geometric measurement of the beads is preferably carried out after complete solidification of the molten bath. This process step is preferably interposed during the welding method of a bead, since solidification is not completed immediately after the emission stop. The time until complete solidification of a process zone is preferably used to weld the pin pair following it. After solidification of the previous molten bath, for example, a scanner optic changes the measuring range to the last welding position during an ongoing welding method in order to analyze the length and width extension of the previous bead. Similarly, the growth of the weld bead is also monitored at the current welding position. As soon as the weld bead shows a critical length or width extension at the current processing position, the emission of the laser radiation is stopped. The minimum dimension of the permissible air and creepage distance (i.e., the minimum distance between adjacent welds) is used as the evaluation variable for this purpose, since the distance to the previous pin pair and thus to the previous weld bead is known—in particular taking into account the previously detected dimensions of the previous weld bead. Accordingly, the dimension of the process zone extension is controlled via the energy input in order to avoid falling below the minimum required air and creepage distance.

### BRIEF DESCRIPTION OF THE DRAWINGS

Examples of embodiments of the invention are explained in more detail below with reference to the accompanying drawings wherein it is shown by

FIG. 1 is a schematic block diagram of a welding arrangement with a component having pairs of conductor ends protruding from the component—as an example of a group of conductor ends—and an embodiment of a welding apparatus for welding the pairs of conductor ends;

FIGS. 2a to 2e are each a top view of a pair of conductor ends to be welded, with process zone conditions at different times of a welding method inclusive dimension lines;

FIG. 3 is a perspective view of another pair of conductor ends with different relative positions of the conductor ends before welding, corresponding to the state of FIG. 2a;

FIGS. 4a to 4d, 5a to 5d and 6a to 6d are each an isometric view of the pair of conductor ends to be welded corresponding to the states of FIGS. 2a to 2d, namely in perspective view, in side view and in plan view.

### DETAILED DESCRIPTION OF THE PREFERRED EMBODIMENTS

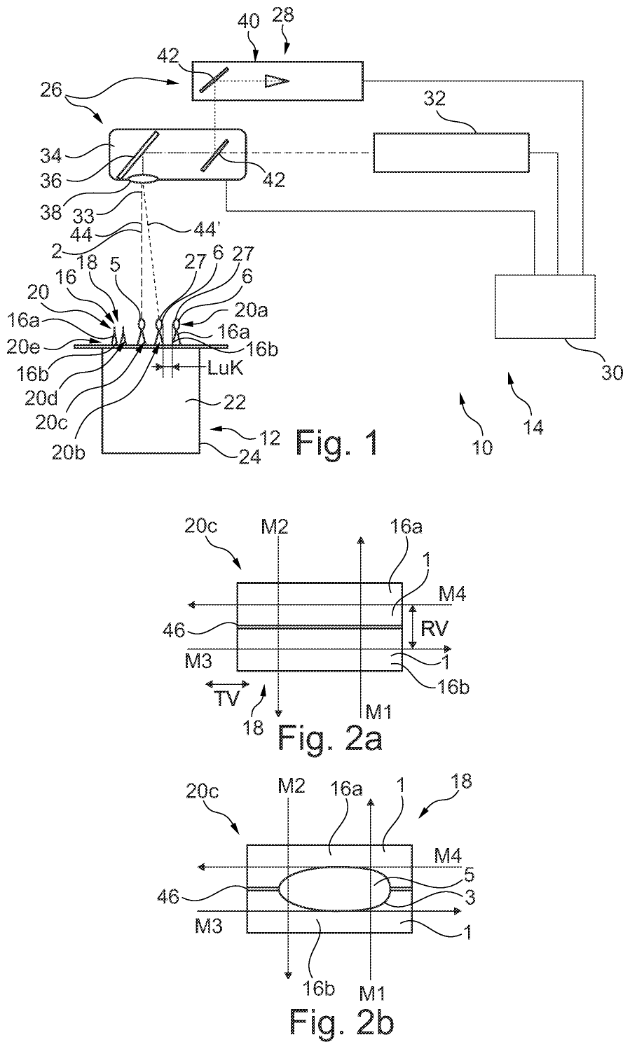

FIG. 1 shows an embodiment of a welding arrangement 10 comprising a component 12 to be processed and a welding apparatus 14. Conductor ends 16, 16a, 16b protrude from the component 12 and are organized into groups of conductor ends 18, in particular pairs of conductor ends 20, of conductor ends 16a, 16b to be connected to each other. The component 12 is a component of an electric machine to be mass-produced, such as an electric motor to be used as a traction motor for electric or hybrid vehicles. Coil windings of the component 12 are produced by connecting conductor ends 16.

For example, the component 12 is a stator 22 of the electric motor. The conductor ends 16 are, for example, the ends designated as pins 1 of hairpins, i.e., of approximately U-shaped pieces of wire, in particular of rectangular wire, which are inserted into grooves of a housing (laminated core) 24 of the stator 22. By connecting the free ends of the hairpins, the coil windings extending through the stator 22 in a wave-like manner can be formed. For more details on the structure of the stator 22, the hairpins and the manufacturing method for the stator 22, reference is made to the literature [1] to [4] mentioned at the beginning. As can be seen from this literature, before the coil windings are welded together, a large number of conductor ends 16 protrude from one end of the housing 24, mostly grouped into pairs of conductor ends 20, 20a-20e. A first conductor 16a and a second conductor 16b of a pair of conductor ends 20, 20a-20e are usually to be welded together so as to connect one hairpin to another hairpin. However, it may also be the case that three or more conductor ends 16 are to be connected to each other, which is then also to be carried out by welding as described in more detail below. The welding will be explained below with reference to the example of the group of conductor ends 18 being formed as a pair of conductor ends 20.

A clamping device 25 of the type explained in more detail in [4] can be provided on the component 12, which clamps the conductor ends 16a, 16b of each pair of conductor ends 20 to be welded together. For reasons of illustration, five pairs of conductor ends 20a-20e, which are welded in succession by the welding apparatus 14, are schematically and roughly depicted in FIG. 1. In practice, a significantly larger number (e.g., 150 to 300 or even more) of pairs of conductor ends 20 are to be welded per component 12. In the embodiment of FIG. 1, the first and second pairs of conductor ends 20a, 20b have already been completely welded, which is indicated by a welding seam 6 with a weld bead 27, while the third pair of conductor ends 20c is currently in the welding method, which is indicated by a molten pool 5. The fourth and fifth pairs of conductor ends 20d, 20e would then be welded thereafter.

Accordingly, the welding apparatus 14 is designed for welding conductor ends 16, 16a, 16b of a component 12 for an electrical machine, which conductor ends are organized into groups of conductor ends 18, 20. The welding apparatus 14 has a welding means 26, a measuring device 28 and a control device 30.

The welding apparatus 26 is configured to apply welding energy to a group of conductor ends 18. In particular, the welding apparatus 26 may be any beam welding apparatus capable of directing a welding beam 33 sequentially onto the groups of conductor ends 18, 20, 20a-20e. Alternatively, the welding apparatus 26 may comprise a TIG or plasma welder, wherein the conductor ends 20, 20a-20e are successively moved into the welding zone. In the preferred embodiment shown in FIG. 1, the welding apparatus 26 has a laser 32 for generating a laser beam 2 as a welding beam 33 for laser welding and laser optics 34 for deflecting and focusing the laser beam 2. In particular, the laser optics 34 comprises one or more galvanometrically driven deflection mirrors 36 and an optical element 38 for focusing the laser beam 2 and for adjusting the beam cross-section of the laser beam 2. The laser optics 34 may also include apertures (not shown) for blanking out all or an adjustable amount of the laser beam 2. Thus, the laser optics 34 is an example of a device for directing a welding beam 33 onto the group of conductor ends 18 and of a device for starting, stopping, increasing and decreasing the welding energy input to the group of conductor ends 18. At least some of these functions may, of course, be performed by other suitable devices, such as on the laser 32 itself or on or in the beam path between the laser 32 and the laser optics 34.

The measuring device 28 is designed at least for detecting a relative position of a first conductor end 16a and a second conductor end 16b of the respective group of conductor ends 18, 20, 20a-20e. The measuring device 28 can be designed differently for this purpose as long as it can detect the relative positions between the conductor ends 16a, 16b and transmit a measurement signal indicating the relative position to the control device 30. This is preferably effected by optical measuring methods, such as image capture or optical length measurements, and various measuring devices are available on the market for this purpose. In particular, the measuring device 28 is designed to measure a plurality of dimensions of the end region of the group of conductor ends 18, 20, 20a- 20e. In the preferred embodiment shown in FIG. 1, the measuring device 28 operates via time-of-flight measurement of reflected measuring radiation 40 and more particularly by means of optical coherence tomography (OCT). For this purpose, the measuring device 28 has an OCT device 40 with deflection device (scanner) 42. As can be seen e.g., from literature

[5] “Optical coherence tomography,” Wikipedia entry, wikipedia.org, retrieved 2020 Mar. 26,

such OCT devices 40 for performing optical coherence tomography are available on the market for completely different purposes. They are currently used in medicine, particularly for detecting the fundus of the eye in ophthalmology. The deflection device 42 can be used to scan a measuring beam 44 of the OCT device 40 over the respective group of conductor ends 18, 20, 20a-20e to detect the position of the contours of the individual conductor ends 16a, 16b or even the contours, the dimensions and the volume of the molten pool 5 or the weld bead 27 or the welding seam 6.

The control device 30 is designed to control a welding energy input to the conductor ends 16a, 16b to be welded depending on the measurement signal of the measuring device 28. In particular, the welding energy input can thus be controlled depending on the detected relative position of the conductor ends 16a, 16b. The control device 30 has, for example, a controller comprising a computing unit and a memory in which control instructions are stored as software. The control instructions cause the welding apparatus 14 to perform the welding method explained in more detail below.

The measuring device 28 and the measuring method carried out with it are based on optical coherence tomography, OCT for short: In a preferred embodiment of the measuring device 28, a measuring beam 44 with a wavelength of approx. 840 nm is emitted. The height information of the area to be measured at the group of conductor ends 18 in the z-direction is determined by calculating the propagation time of the reflected signal.

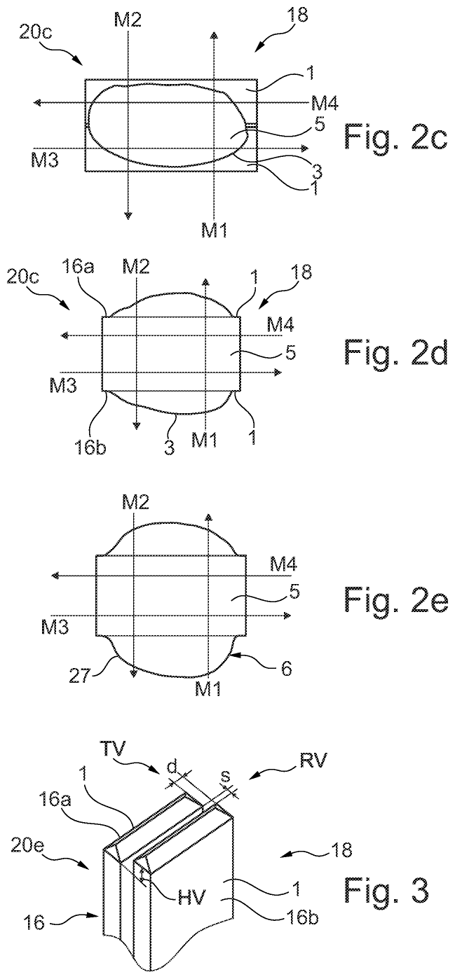

In one possible embodiment of the welding method, in contrast to the literature cited in [1] to [4], no joint cutting of the conductor ends 16 takes place after clamping and before welding. In particular, uncut hairpins—pins 1—are present as conductor ends 16, 16a, 16b, as shown in FIGS. 2a, 4a, 5a, 6a and 3, which show pairs of conductor ends 20, 20c, 20d before the welding method. FIG. 2a and FIGS. 2b to 2e also show dimension lines M1-M4 for performing the OCT measurements according to a preferred measurement strategy during the different steps or phases of the welding method.

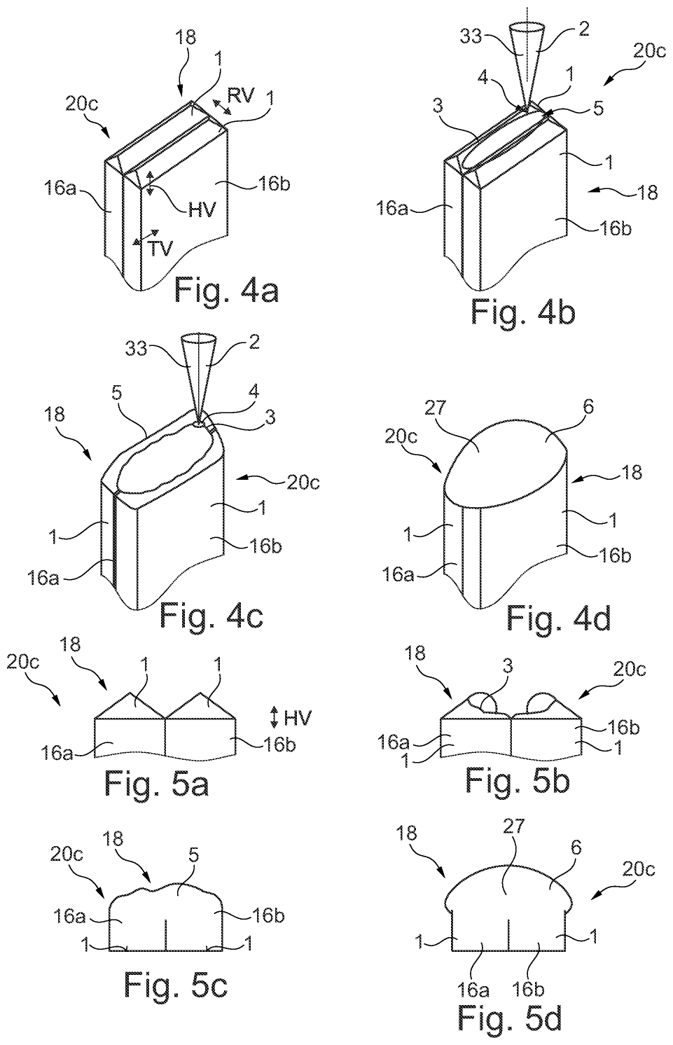

The measurement strategy is implemented as a double cross (see the intersecting dimension lines M1 to M4) to characterize the positions of the uncut hairpins before welding in the x-y-z direction. Thus, the size of a gap 46 between the conductor ends 16a, 16b, a height offset HV between the conductor ends 16a, 16b, a radial offset RV (with respect to the radial direction of the component 12 having a central axis), and a tangential offset TV between the conductor ends 16a, 16b can be detected. For example, FIG. 3 shows another pair of conductor ends 20e in which the conductor ends 16a, 16b have correspondingly larger offsets with respect to each other than in the pair of conductor ends 20c shown in FIGS. 2a-2e and 4a-4d to 6a-6d.

According to the positions of the conductor ends 16, 16a, 16b, a pin-related power distribution or area energy, i.e., a power distribution or area energy to be individually set for the group of conductor ends 18, 20c currently to be welded, can be calculated so that a homogeneous weld bead 27 is obtained. Furthermore, the process zone dimension can be measured iteratively during the welding method—in this case by measuring the dimensions of the molten pool 5 along the dimension lines M1 to M4—in order to achieve defined limit values of the bond cross-section or not to exceed the permissible bead dimension. In detail, the change in length, width and height extension is quantified during the process. As the volume of the material of the conductor ends, e.g., copper, increases during melting, the height of the pair of conductor ends 20c to be welded changes. With continued energy input, a complete melt blanket results until a lateral bead overhang occurs with sufficient melt volume (see progress in FIGS. 2b to 2e). This is directly proportional to a specific melt volume and thus to a defined bond cross-section (cross-section over which the conductor ends 16a, 16b are fully bonded together).

In detail, optical coherence tomography can thus be used to measure the change in the process zone dimension during a welding method. Based on this, a correlation to the bond cross-section can be established. As soon as the desired melt volume or the required bond cross section is available, the energy input can be stopped. In this way, a situation-dependent energy input can be implemented, which avoids scrap and increases the process capability.

FIG. 1 shows, for example, a situation in which the welding beam 33—laser beam 2—of the welding apparatus 14 is directed to the third pair of conductor ends 20c in order to weld this pair of conductor ends 20c. In this case, the introduction of the welding energy is controlled depending on the relative position of the conductor ends 16a, 16b and depending on the current size of the molten pool 5 measured inline, as shown in FIGS. 2b to 2e. As shown in FIG. 1, the second pair of conductor ends 20b has been welded shortly before, whose molten pool 5 is just cooling to a weld bead 27, and the first pair of conductor ends 20a has been welded before the first pair whose weld bead 27 has already completely solidified.

In addition to process control for setting individual target variables of the bead dimension and the bond cross-section, the illustrated embodiment of the welding apparatus 14 and the welding method also enable characterization of the welding results.

Here, geometric measurement of the weld beads 27 is carried out after complete solidification of the molten pool 5. This process step is interposed during the welding method of a bead, since solidification is not completed immediately after the emission stop. The time until complete solidification of a process zone is used to weld the pin pair following it. After solidification of the previous molten pool, the deflection device 42 of the measuring device 28, e.g., scanner optics of the OCT device 40, changes the measuring range to the last welding position during an ongoing welding method in order to analyze the length and width extension of the previous bead.

In FIG. 1, this is indicated by the dashed measuring beam 44′, which is directed onto the second pair of conductor ends 20b during welding of the third pair of conductor ends 20c in order to measure and evaluate the weld bead 27 of the second pair of conductor ends 20b. Also, the measurement signal of the measurement beam 44′ indicating at least one dimension of the weld bead 27 of the previous weld is included in the control of the energy input of the current weld. Thus, the control device 30 is adapted to control the welding energy input to the pair of conductor ends 20c currently to be welded depending on a characterization of the previous welding result.

Analogously—see the dashed measuring beam 44—the growth of the molten pool 5 is also monitored at the current welding position—here at the third air of conductor ends 20c. As soon as the molten pool 5 at the current processing position shows a critical length or width extension—e.g., shown in FIG. 2e—the emission of the laser beam 2 is stopped.

The minimum dimension of the permissible air and creepage distance LuK (i.e., the distance between adjacent welding seams 6) is used as the evaluation variable for this purpose, since the distance to the previous weld bead 27 is known. Accordingly, the dimension of the process zone extension is controlled via the energy input in order to avoid falling below the minimum required air and creepage distance LuK.

FIGS. 2a to 2e show top views of the pair of pins 1 currently being welded —pair of conductor ends 20c—with process zone dimensions at different times of the process progress including dimension lines M1 to M4. Thus, as shown in FIG. 2a, the size of the gap 46 between the conductor ends 16a, 16b, among others, can be recorded. FIGS. 2b to 2e show the increasing size of the molten pool 5 and thus of the process zone dimensions.

Direct quantification of the current relative positions of the conductor ends 16a, 16b at each current group of conductor ends 18 and direct quantification of the molten pool dimensions may be provided, thereby enabling the progress of the weld to be detected and the welding energy input to be optimally stopped or otherwise controlled.

From a process engineering point of view, optical coherence tomography offers process engineering advantages due to the evaluation of optical measured variables of the process zone dimension. Here, a measuring beam 44 is emitted in a specific wavelength. Height information is generated via the travel time of the reflected radiation. This makes it possible to detect a geometric change in the molten pool 5, which at the same time serves as an input variable for dimensioning the energy input. Thus, the process zone dimension can be quantified and also the pin positions before welding and the weld bead after welding can be measured.

Other measuring methods based on time-of-flight measurements can also be used. Basically, any measuring principle is suitable that can be used to geometrically measure different dimensions of the weld zone.

In embodiments of the welding method, inline measurement of the process zone dimensions thus takes place (during the welding method). It is possible to intervene in the power emission as soon as the specified melt volume and/or the specified bond cross-section are reached. There is a direct evaluation of evaluation variables decisive for the quality of the weld.

Advantages of the preferred embodiment of the welding method are:

quantification of the actual process zone dimension during a welding operation for situation-adjusted energy input

avoidance of excessive energy input and thus oversized melt formation as well as the risk of damage to the insulating varnish

avoidance of insufficient energy input and thus insufficient bond cross-sections

combination of pre-process, in-process and post-process analysis of the welded joint

In particular, the measurement strategy developed allows inline quantification of the process zone geometry and thus control of the energy input to achieve the required bond cross-section.

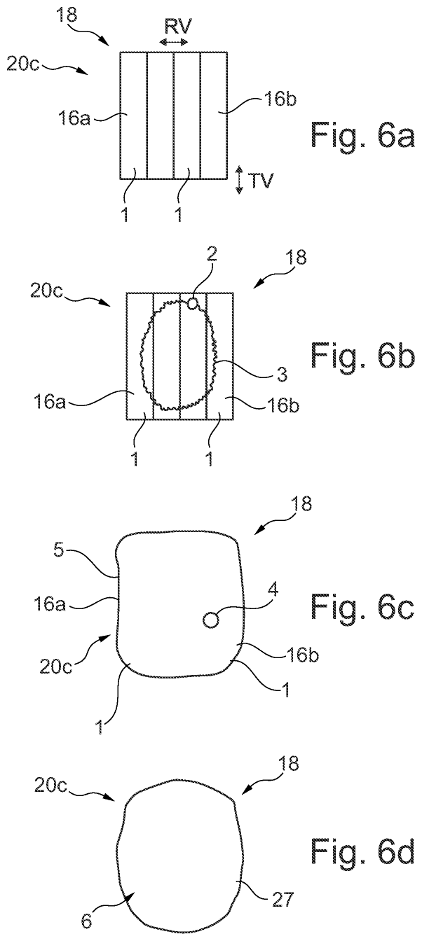

In the following, an embodiment of the welding method is explained in more detail, in which the welding energy input is controlled depending on the relative position of the conductor ends 16a, 16b to be welded. FIG. 2a and FIGS. 4a, 5a and 6a show views of a group of conductor ends 18 for this purpose, using the example of the third pair of conductor ends 20c currently to be welded in FIG. 1. FIG. 3 shows another group of conductor ends 18, for example the fifth pair of conductor ends 20e with deviating relative positions.

By means of the measuring device 28, the height offset HV, the radial offset RV and the tangential offset TV of the conductor ends 16a,16b are detected. The pin positions are characterized with respect to HV, RV and TV. Subsequently, an individual calculation of the energy distribution for the current pair of conductor ends 20c or 20e is performed by means of the control device 30.

In the case of an offset (HV, RV, TV) detected before the process start—see FIG. 3—this can be taken into account in the calculation of the required process zone dimension in order to achieve the required bond cross-sections. In addition, a pin-related energy input can be calculated as a function of the height offsets and implemented on the respective pins 1.

As shown in FIGS. 2b to 2e as well as 4b to 4d, 5b to 5d and 6b to 6d, the process zone dimension is quantified during power emission in accordance with the four exemplarily arranged measurement lines M1-M4. Depending on the process zone dimension—i.e., in particular the dimensions of the depicted weld contours 3—a back-calculation to the associated bond cross-sections is possible. Consequently, an emission stop can be stored for a specific limit value of the bond cross-section so that the pair of conductor ends 20c, 20e currently to be welded is not thermally overloaded. In addition, the welding energy input can be controlled, for example, by controlling the size of the laser spot 4.

In one embodiment, only the relative position of the conductor ends 16a, 16b is detected to control the welding energy input. In another embodiment, the relative position of the conductor ends is detected and the molten pool dimensions are quantified inline to control the welding energy input. Other embodiments have still additional parameters by which the welding energy input is controlled.

In the process indicated in FIG. 1 with the measuring beam 44′, the previous weld location is measured and used as an input variable for the control at the current weld location (post-process weld location 1=in-process weld location 2). In particular, the bead geometry of already welded pairs of conductor ends 20a, 20b (weld location 1) is detected during the welding method for the current pair of conductor ends 20c (weld location 2).

In a further embodiment, one of the pairs of conductor ends 20d, 20e to be welded next is measured in advance, e.g., still during the current welding method. For example, a leading measurement of the adjacent pins 1, i.e., in the example of FIG. 1 in particular of the fourth pair of conductor ends 20d and/or the fifth pair of conductor ends 20e—is carried out with respect to the respective relative position, i.e., one or more of the relative offsets HV, RV and TV. As a result, the detection of the relative positions can be faster, and the welding of the respective next pair of conductor ends 20d can start with the input variables of the relative positions immediately after the completion of the previous pair of conductor ends 20c.

In a further embodiment, the air and creepage distance LuK of two adjacent already welded pin pairs is determined. For example, in the welding arrangement 10 of FIG. 1, the air and creepage distance, i.e., in particular the free distance, between the weld beads 27 of the first pair of conductor ends 20a and the second pair of conductor ends 20b is determined. If the value is below a predetermined threshold or prewarning value, the energy input for the current weld is reduced. If the value is above a predetermined maximum value, the energy input may be increased to allow for a larger melt volume and thus a larger bond cross-section.

In yet another embodiment, splashes can be detected. For this purpose, instead of the coarse grid with a few dimension lines M1 to M4, a finer grid and preferably with a simultaneously shorter line length is used for the OCT process. Detection of splashes up to the closed melt blanket is possible. A fine grid with simultaneously shorter line length is used because the melt volume at the start of the process does not exceed the pin cross-section. This makes it possible to draw conclusions about splashes in the event of a significant change in the height level.

In addition to the process zone dimension, a potentially occurring emission of splashed from the process zone can be detected as further information. Splash formation can occur especially during the formation of the keyhole or an emission in the gap. If the measuring line is positioned appropriately, this can be detected by OCT and used as an evaluation variable for the process.

Further embodiments provide for a component-specific adjustment of the energy input per area. In particular, the irradiation location and/or the area energy are controlled as a function of the OCT image.

In one embodiment, the height offset HV is included as a boundary condition for this purpose. This embodiment of the welding method comprises the following steps:

s1) measurement of the clamped pin pair (for example pair of conductor ends 20c or 20e) in the initial state, see FIGS. 2a, 3, 4a, 5a, 6a, in particular by means of OCT, and identification of the height position (z-direction) and the x-y position

s2) identification or calculation of the energy distribution per pin 1 according to the xyz position of the respective pins

s3) a) controlling the surface energy according to the height difference, in particular by controlling contour length, the velocity and/or the power of the welding beam 33, in particular laser beam 2; and/or
b) tracking of the focal plane according to the height difference.

In a further embodiment (may also be present in combination), the radial offset RV is included as a boundary condition for this purpose. This example of the welding method comprises the following steps:

t1) measurement by OCT or the like and identification of the gap 46

t2) calculation of the start position and geometry dimension (surface energy) of the welding beam 33 so that there is sufficient melt volume to close the gap 46

t3) a) controlling the surface energy according to the height difference, in particular by controlling position, contour length, the velocity and/or the power of the welding beam 33, in particular laser beam 2; and/or
b) tracking of the focal plane according to the height difference.

The energy input is to be adjusted according to the height offset HV and the gap dimension—e.g., determined via the radial offset RV—so that a homogeneously pronounced welding seam 6/weld bead 27 is obtained.

Of course, embodiments of the invention may include all of the functions or any combinations of the foregoing embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 pin
2 laser beam
3 welding contour
4 laser spot
5 molten pool
6 welding seam
10 welding arrangement
12 component
14 welding apparatus
16 conductor end
16a first conductor end
16b second conductor end
18 group of conductor ends
20 pair of conductor ends
20a first pair of conductor ends
20b second pair of conductor ends
20c third pair of conductor ends
20d fourth pair of conductor ends
20e fifth pair of conductor ends
22 stator
24 housing
25 clamping device
26 welding apparatus
27 weld bead
28 measuring device
30 control device
32 laser
33 welding beam
34 laser optics
36 deflecting mirror
38 optical element
40 OCT device
42 deflection device
44 measuring beam (on current weld zone)
44′ measuring beam (on previous weld zone)
46 gap
HV Height offset
M1 first dimension line
M2 second dimension line
M3 third dimension line
M4 fourth dimension line
LuK air and creepage distance
RV radial offset
TV tangential offset

1-13. (canceled)

14. A welding method for welding conductor ends organized into groups of conductor ends of a component for an electrical machine, comprising:
a) detecting a relative position of a first conductor end and a second conductor end of a group of conductor ends; and
b) controlling a welding energy input to the conductor ends to be welded depending on the detected relative position.

15. The welding method according to claim 14, further including
c) detecting at least one size parameter of a molten pool formed during welding, and
d) controlling the welding energy input depending on the detected size parameter of the molten pool.

16. The welding method according to claim 14, further including
e) detecting at least one size parameter of a weld bead solidified after welding; and
f) controlling the welding energy input during a subsequent welding of a further group of conductor ends depending on the detected size parameter of the solidified weld bead.

17. The welding method according to claim 16, wherein step e) comprises at least one of
e1) being performed on a first group of conductor ends, while step b) is already being performed on a second group of conductor ends;
e2) being performed to characterize a result of the welding; or
e3) comparing the at least one size parameter with a predetermined parameter value or parameter value range.

18. The welding method according to claim 14, wherein
at least one of steps a), c) and/or e) comprises at least one or more of the following steps:
a1) position measuring using optical measuring methods;
a2) position measuring by means of time-of-flight measurement of reflected radiation;
a3) performing an optical coherence tomography;
a4) alternately directing a measuring radiation to different groups of conductor ends;
a5) measuring distances or stretches in at least two dimensions at the group of conductor ends;
a6) measuring a distance or a stretch in a direction of an extension of conductor sections comprising ends of the conductors;
a7) determining a distance between the conductor ends;
a8) measuring a height offset between the conductor ends;
a9) determining a cross-sectional area of the end region of a group of conductor ends;
a10) determining a volume of an end region of the group of conductor ends;
a11) measuring at least one of a thickness, a width or a height of the end region at the group of conductor ends;
a12) detecting a change in at least one dimension of the end region of the group of conductor ends.

19. The welding method according to claim 14, wherein at least one of step b), step d) or step f) comprises at least one or more of the following steps:
b1) directing a welding beam onto the group of conductor ends;
b2) starting the welding energy input to the group of conductor ends;
b3) stopping the welding energy input to the group of conductor ends;
b4) increasing or decreasing the welding energy input to the group of conductor ends; or
b5) changing a beam cross-section of a welding beam on the group of conductor ends.

20. A welding apparatus for welding conductor ends organized into groups of conductor ends of a component for an electrical machine, comprising:
a welding means for inputting welding energy to a group of conductor ends;
a measuring device for detecting a relative position of a first conductor end and a second conductor end of the group of conductor ends, and
a control device which is configured to control a welding energy input to the conductor ends to be welded as a function of the detected relative position.

21. The welding apparatus according to claim 20,
wherein the measuring device is configured to detect at least one size parameter of a molten pool produced during welding, and
wherein the control device is configured to control the welding energy input as a function of the detected size parameter of the molten pool.

22. The welding apparatus according to claim 20,
wherein the measuring device is configured to detect at least one size parameter of a weld bead solidified after welding, and
wherein the control device is configured to control a welding energy input during subsequent welding of a further group of conductor ends as a function of the detected size parameter of the solidified weld bead.

23. The welding apparatus according to claim 22, wherein the measuring device at least one of:
has at least one or more deflection mirrors by means of which measuring radiation can be selectively guided to different groups of conductor ends, and is configured to measure the size parameter of the weld bead solidified after welding at a first group of conductor ends and at the same time to detect at least one of a relative position of the conductor ends or the size parameter of the molten pool already at a second group of conductor ends;
is configured to evaluate a result of the welding; or
comprises a comparison device for comparing the at least one size parameter with a predetermined parameter value or parameter value range.

24. The welding apparatus according to claim 20, wherein the measuring device is at least one device selected from a group of measuring devices comprising:
a measuring device for position measurement by means of optical measuring methods;
a measuring device for position measurement by means of time-of-flight measurement of reflected radiation;
a measuring device for performing optical coherence tomography;
a measuring device for alternately directing a measuring radiation to different groups of conductor ends;
a measuring device for measuring distances or stretches in at least two dimensions at the group of conductor ends;
a measuring device for measuring a distance or a stretch in a direction of the extension of the conductor sections comprising the conductor ends;
a measuring device for measuring a distance between the conductor ends;
a measuring device for measuring a height offset between the conductor ends;
a measuring device for determining a cross-sectional area of the end region of the group of conductor ends;
a measuring device for determining a volume of the end region of the group of conductor ends;
a measuring device for measuring a thickness, a width and/or a height of the end region at the group of conductor ends; or
a measuring device for detecting a change in at least one dimension of the end region of the group of conductor ends.

25. The welding apparatus according to claim 20, wherein the control device is configured to control the welding apparatus to at least one of:
b1) direct a welding beam onto the group of conductor ends;
b2) start the welding energy input to the group of conductor ends;
b3) stop the welding energy input to the group of conductor ends;
b4) increase or decrease the welding energy input to the group of conductor ends; or
b5) change a beam cross section of a welding beam on the group of conductor ends.

26. A computer program product comprising machine-readable control instructions which,
when loaded into a controller of a welding apparatus for welding conductor ends organized into groups of conductor ends of a component for an electrical machine, the welding apparatus comprising:
a welding means for inputting welding energy to a group of conductor ends;
a measuring device for detecting a relative position of a first conductor end and a second conductor end of the group of conductor ends, and
a control device which is configured to control a welding energy input to the conductor ends to be welded as a function of the detected relative position,
cause the welding apparatus to perform the welding method according to claim 14.
